(19) United States
(12) Patent Application Publication
(10) Pub. No.: US 2006/0074679 A1
(43) Pub. Date: Apr. 6, 2006

(54) System and method of delivering live performance recordings

(76) Inventors: Daniel A. Pifer, Brooklyn, NY (US); Paul C. Sanwald, Brooklyn, NY (US)

Correspondence Address: Stephen Chin, Esq.;REED SMITH LLP, 599 Lexington Avenue, New York, NY, 10022, US

(21) Appl. No.: 10/931,723

(22) Filed: Sep. 1, 2004

(51) Int. Cl. G10L 21/00

(52) U.S. Cl. 704/270

(57) ABSTRACT

The invention relates to a system and method for purchasing a live performance recording. A live performance is recorded and edited. The live performance recording is compressed and tagged at a production means, and transferred to a kiosk soon after the performance ends. Consumers purchase a media storage device, the live performance recording, or both at the kiosk. The kiosk accepts consumer information to purchase the digital media at a later date and collate marketing information. Sales and marketing information is transmitted from the kiosk, through the production means, and stored in a central database. In a preferred embodiment, the kiosk operating system has the ability to recognize a wide variety of USB compatible external storage devices.

### BACKGROUND OF THE INVENTION

1. Field of the Invention

The present invention relates to devices, systems, and processes related to delivery of live performance recordings to a point of sale.

2. Brief Description of the Related Art

The ability to digitally record music has greatly changed how performance art, whether recorded live or in a studio, is delivered to consumers. Recordings previously sold on cassettes, vinyl records, and VHS tapes can now be transferred in electronic files to a variety of portable forms, such as compact discs (CDs), or simply stored and played back by a computer. Typically, a performance is recorded, edited, and a final recording is produced. The final recording is then copied onto some media form, such as CDs or VHS tapes, to be sold in volume. The time between recording, editing, and sale to the public is usually long, typically months and sometimes up to a year in duration.

Providing recordings of live performances to consumers is one segment of the performance media market. The live recording provider faces several challenges. One challenge is to achieve a high quality of sound. Another difficult challenge is to provide the recording near to the time of an actual performance, when consumers are most interested in buying a recording of a show the consumer just attended.

U.S. Pat. No. 6,614,729 and U.S. Publication No. US2004/0095852 to Griner, et al., describe a system for recording a performance event, splitting the event into track files, creating an event file, and duplicating the event file on recorded media, namely CDs. Editing each track during the performance allows a final product of good quality to be produced quickly. The CDs are subsequently sold to consumers via conventional retail methods.

U.S. Publication Nos. 2003/0235316 and 2003/0236581 to Chambers, et al., describe a system for recording live performances to a CD Rom. Consumers pre-purchase a recording prior to the show, and are issued a voucher to present when picking up the recording after the show. Chambers describes placing a CD burner in a mobile unit, such as a van, located outside of a concert venue, where consumers can pick up the recording after the show.

Some prior kiosks generally relate to digital music recordings. For example, U.S. Pat. Nos. 5,963,916 and 5,237,157 to Kaplan describe a kiosk which allows the consumer to select and listen to portions of recorded music. The consumer listens to these portions of recorded music to determine whether to buy a compact disc. The consumer does not make a purchase at the kiosk, and instead must purchase a recorded CD at the retail store.

Conventional systems and methods do not provide downloadable recordings. Prior systems and methods also do not provide a fast and simple way to obtain a live performance recording. Prior systems further do not provide a point of purchase for live performance recordings or for external media storage devices. Prior systems do not provide a point of purchase where live performance recordings can be directly downloaded to an external storage device.

### SUMMARY OF THE INVENTION

The invention relates to a system and method for purchasing a live performance recording. A live performance is recorded and edited. The live performance recording is compressed and tagged at a production means, and transferred to a kiosk soon after the performance ends. Consumers purchase a media storage device, the live performance recording, or both at the kiosk. The kiosk accepts consumer information to purchase the digital media at a later date and collate marketing information. Sales and marketing information is transmitted from the kiosk, through the production means, and stored in a central database. In a preferred embodiment, the kiosk operating system has the ability to recognize a wide variety of USB compatible external storage devices and other peripheral connectors, for example, devices using a Firewire.

An object of the present invention is to provide a live performance recording to a consumer shortly following the performance. Another object of the present invention is to provide a means for placing a live performance recording onto an external storage device. Still another object of the present invention is to provide a point of sale where purchased live performance recordings can be downloaded directly to an external storage device. Yet another object of the present invention is to provide a means for tracking sales and marketing data for live performance recording transactions.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus, given only by way of example, and with reference to the accompanying drawings, in which:

FIG. 1 illustrates a system for delivering a live performance recording according to the present invention.

FIG. 2 illustrates a live music kiosk according to the present invention.

FIGS. 3 illustrates a preferred media storage device in accordance with the present invention.

FIGS. 4A to 4F illustrate a preferred method of providing live performance recording according to the present invention.

FIGS. 5A to 5H illustrate exemplary kiosk screens in a preferred embodiment in accordance with the present invention.

### DESCRIPTION OF THE PREFERRED EMBODIMENTS

Referring to the drawing figures, like reference numerals designate identical or corresponding elements throughout the several figures.

The present invention has been made in view of the above circumstances and provides, among other things, a system and method of providing a live performance recording to a consumer shortly following the performance. The present invention further provides a means for placing a digital media recording of a live show onto a storage device. The present invention provides a point of sale where purchased live performance recording can be downloaded directly to a storage device. The present invention also provides an interface for tracking sales and marketing data for live performance recording sales.

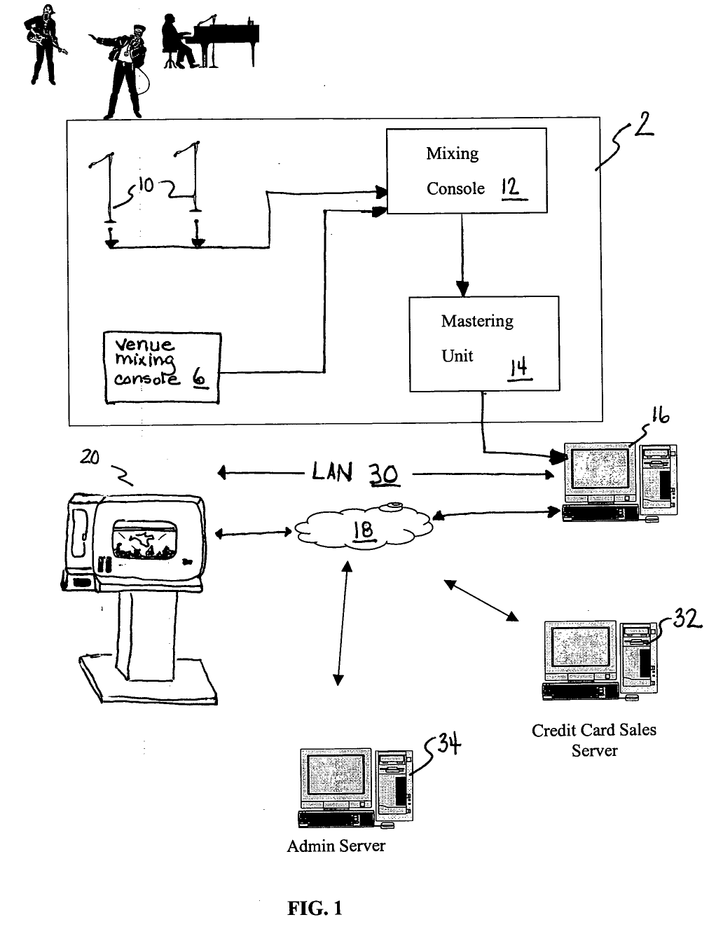

Referring to FIG. 1, a system and method for delivering live performance recording in accordance with the present invention is illustrated. The system includes a mastering means 2, a production means 16, a kiosk 20, an administrative server 34, and a credit card sale server 32. The production means 16, kiosk 20, administrative server 24, and credit card sale server 22 are electrically connected via a distributed network 18, for example, the Internet. Preferably, the production means 16 and the kiosk 20 are also electrically connected via a local area network (LAN) 30, which allows any command and control of the kiosk 20 from the production means 16 to be performed quickly and easily. LAN 30 should have a minimum 10/100 speed Ethernet capability.

A live performance is given at a venue, such as a bar, club, or concert hall. The mastering means 2 records the live performance and provides a master signal, preferably with minimized background noise and a balanced representation of vocals and instruments. The mastering means 2 is generally formed from a variety of recording equipment. Preferably, the mastering means 2 has a pair of condenser microphones 10, a mixing console 12, and a mastering unit 14. In a preferred embodiment, the performance is recorded from two sources. The first source is the pair of condenser microphones 10 placed at the front of the stage where the live performance is given. The second source is a stereo feed (not shown) taken from a venue mixing console 6. The stage and stereo components are mixed to form a stereo pair. The stereo pair is equalized as needed, as known by one of ordinary skill in the art. The mixed signal is input to a mastering unit 14. The mastering unit 14 is used to adjust signal dynamic range, and boost output as needed, to form a master signal. Mixing consoles, mastering units and their functions are well known to one of ordinary skill in the art. Various recording methods are also well-known in the art. It will be appreciated that the mastering means 2 that records a live performance and creates a master signal may be formed from a wide variety of recording equipment without departing from the scope of the present invention.

The production means 16 is used in part to perform the tasks of editing the master signal and formatting the digital file recording from that master signal. The production means 16 is preferably formed from at least one computer with a sound card, one or more processors having a combined speed of at least 2.4 gigahertz, and preferably a Windows 2000® or later operating system. The production means is equipped with various off-the-shelf software programs for music production that can create compressed files, which are particularly suited for MP3 players, or uncompressed files, such as wave files, and separate files into digital tracks using currently available software programs such as CDWave, made by MiLo Software Products. Preferably, the file is compressed to accommodate current bandwidth capabilities and still transmit and download the recording in a minimal amount of time. However, it will be appreciated by one of ordinary skill in the art that uncompressed files can currently be used with the present invention. Alternatively, software for copying the final recording to a CD ROM, also known as burning, such as CDRwin, can be used with the production means 16 if selling CDs is additionally desired. While the production means 16 is preferably a single computer, it will be appreciated by one of ordinary skill in the art that the tasks performed by the production means 16 could be divided between one or more computers without departing from the scope of the present invention.

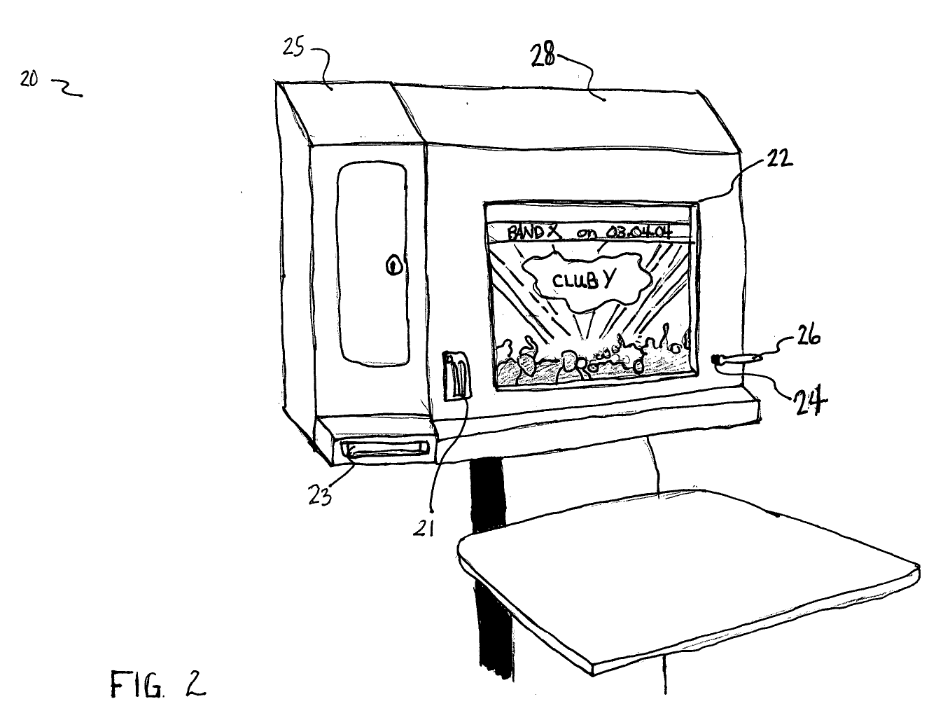

Referring to FIGS. 1 and 2, the kiosk 20 in accordance with the present invention is illustrated. The kiosk 20 provides a point of sale where consumers can purchase live performance recordings. The kiosk 20 is supported by a web enabled kiosk computer contained inside a housing 28. A user interface 22 displays web pages that allow a consumer to make purchases, further described below. Preferably, the user interface 22 is a touch screen. In an alternative embodiment, a monitor and keyboard and mouse peripherals form the user interface 22. A USB port 24 accepts external media storage devices 26, such as a pen drive. The USB port 24 is an interface to the kiosk computer. Preferably the USB port 24 is USB 2.0 compatible, in order to transmit between any device and the computer at the highest rate of speed and bandwidth currently available. A means for accepting credit information 21 allows a consumer to enter payment information, for example a credit card number, for executing an on-line transaction at the kiosk 20. Preferably, the means for accepting credit information 21 is a card reader, where a consumer can simply swipe a credit card as is known by one of ordinary skill in the art. Alternatively, the means for accepting credit information 21 is a touch screen, or a peripheral mouse and keyboard, where the consumer types in credit card information. In another alternative embodiment, the means for accepting credit information 21 is a biometric reader, such as a fingerprint scanner, a retinal scanner, or the like, which remotely associates the consumer to payment information. Preferably, the means for accepting credit information 21 and USB port 24 are situated towards the front and lower end of the kiosk 20, making the kiosk 20 accessible to people that are handicapped, or of different heights.

The kiosk 20 has a storage device dispenser 25 with a chute 23 dispenses media storage devices 26 if a consumer chooses to buy a device 26 at the kiosk 20. Alternatively, storage devices 25 can be packaged with peripherals, such as devices using Firewire, and dispensed, or peripherals can be dispensed individually in addition to any selected storage device 25. Programmed instructions are stored on the kiosk computer which enable the storage device dispenser 25 when a storage device 26 is purchased at the kiosk 20. In a preferred embodiment, the production means manages the operation of kiosk 20 and the administrative server 34 tracks sales and administrative information obtained through the kiosk.

The kiosk computer has high-speed capability in order to receive, process, and distribute a live performance recording quickly and efficiently. Preferably, the kiosk computer has a processor speed of at least one Gigahertz, at least 256 megabytes of Random Access Memory (RAM), at least a 10 Gigabyte hard drive, and more preferably a 30 Gigabyte hard drive. The kiosk computer preferably operates with a Linux Redhat 9 operating system, which is particularly well-suited to interface with USB 2.0 compatible storage devices and touch screen technology. However, other Linux-based operating systems or Windows 2000, or later, and Mac OSX or later may be used without departing from the scope of the present invention. In a preferred embodiment, the USB configuration files are altered to accept a wide variety of storage devices. Typically, when a device is plugged in to a USB port, the device identifies itself to the operating system. USB configuration files contain descriptions of devices the operating system will accept. In order to make the kiosk compatible with a wide variety of storage devices, wild card device descriptions are programmed into the USB configuration files. In a preferred embodiment the wild card descriptions include only a key word, for example, the word storage, so that any device that identifies itself with a description including the word storage would be accepted at the kiosk 20. In this manner, any media storage device 26 that identifies itself as such, whether it is an MP3 player, a portable hard drive, a pen drive, flash card, or the like, is recognized by the kiosk computer. It will be appreciated that while the word storage is preferably used as the keyword identifying media storage devices, any naming convention or combination of naming conventions used in the industry to identify storage devices may be used in altering the USB configuration files without departing from the scope of the present invention. The kiosk computer stores and executes instructions for executing sales. The kiosk computer accepts commands from the production means 16. Web page displays which prompt a consumer through the required steps to make a purchase are stored in the kiosk and displayed according to what the consumer chooses to purchase. The kiosk computer instructions automatically cycle displays when a consumer response is not required. For example, once one consumer has finished a transaction, a thank-you screen would be cycled for the requisite time period, and then the kiosk computer would automatically proceeds to a beginning or index display allowing another transaction to begin. Cycles preferably range from 2 to 10 seconds, and more preferably from 3 to 5 seconds.

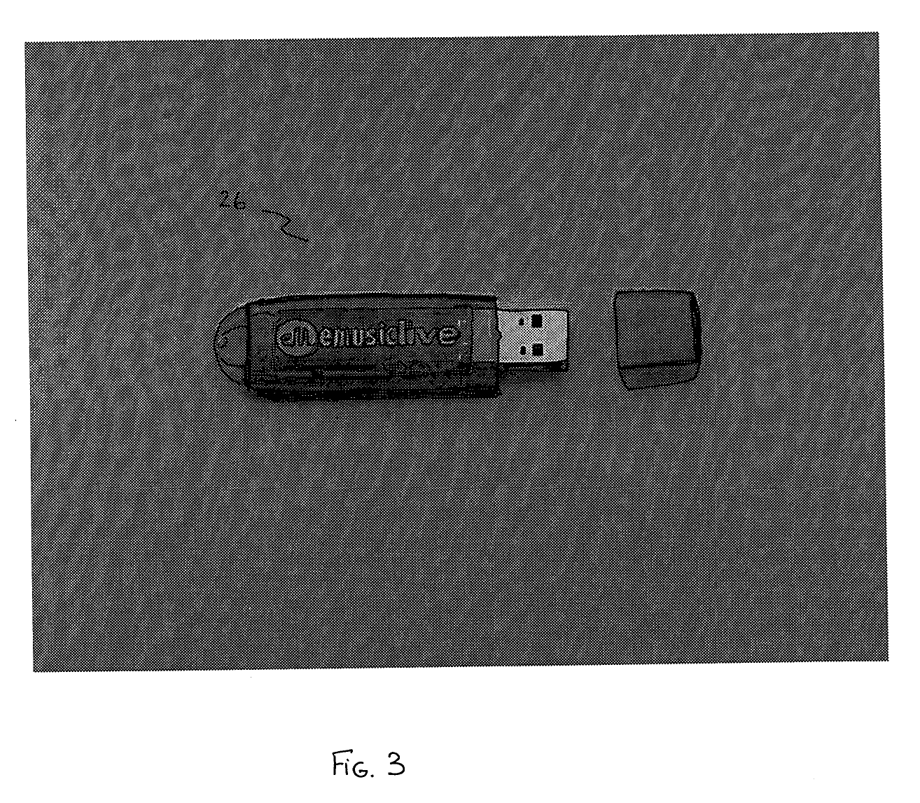

Referring to FIGS. 2 and 3, a preferred media storage device in accordance with the present invention is illustrated. The media storage device 26 illustrated in FIG. 3 is a flash drive, and more preferably, a pen drive. A pen drive is most preferred because it is both portable, and has a robust casing which protects the device 26 during the dispensing process. Other flash drive devices are suitable for dispensing; for example flash cards and memory sticks. Several other media storage devices may be used to download live performance recordings through the USB port 24. Some examples are biometric flash drives, USB flash drive watches, car radio transmitters, and MP3 players. MP3 players are available in many forms, for example, the iPod®, made by Apple Computer, Inc., of Cupertino, Calif., or a wide variety of MP3 players made by River America of Milpitas, Calif., or Creative Labs, Inc., of Singapore and Milpitas, Calif. It will be appreciated by one of ordinary skill in the art that some media storage devices will interface directly to the USB port 24, while others connect to the kiosk computer through a bus, such as a firewire.

Referring back to FIG. 1, the credit card sales server 32 is connected to the present system via the distributed network 18. The credit card sales server 32 processes transactions, and provides a response either approving or denying each credit card transaction made at the kiosk 20. The administrative server 34 is also is connected to the present system via the distributed network 18. The administrative server stores at least one database of administrative information. Administrative information includes all the data related to selling live performance recordings, for example, sales, marketing, permissions, performance dates and times, band names, and the like. Preferably, access to the administrative information is web hosted, so that a group who sells their live show recordings through the system can access the administrative information, and track how well shows sell overall, at various venues, and any other desired sales and marketing information. However, the administrative server can be locally located and still be within the scope of the present invention.

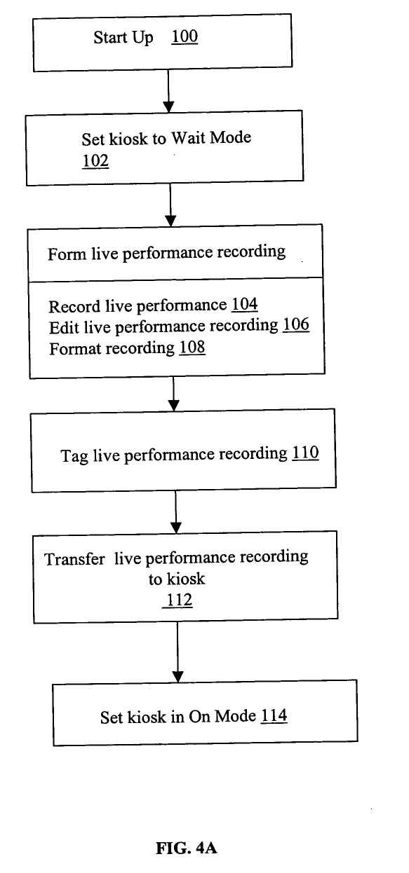

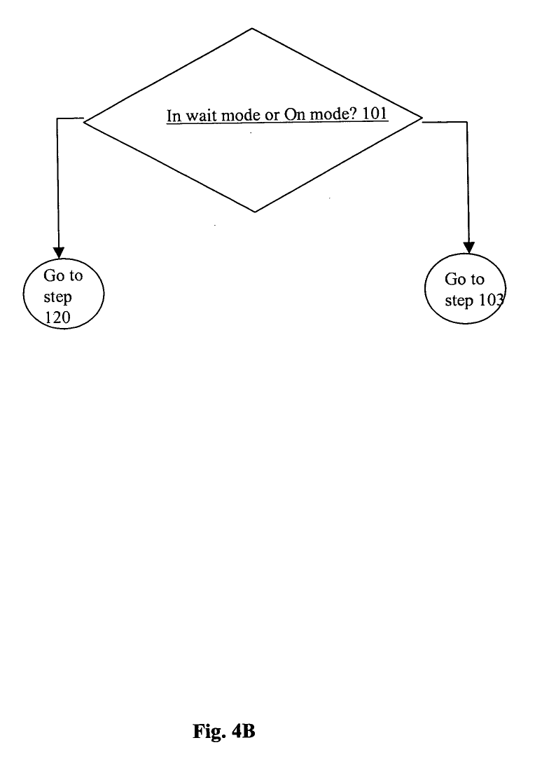

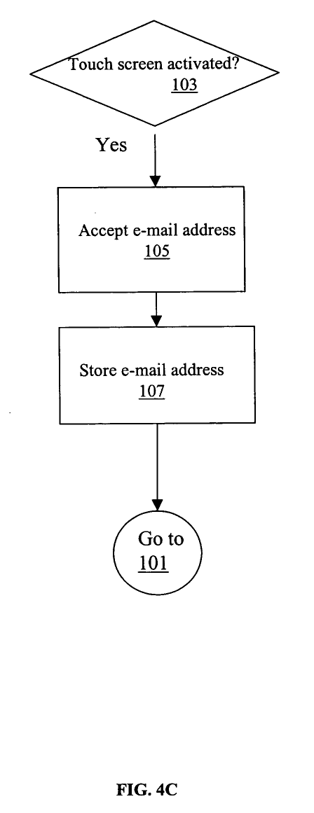

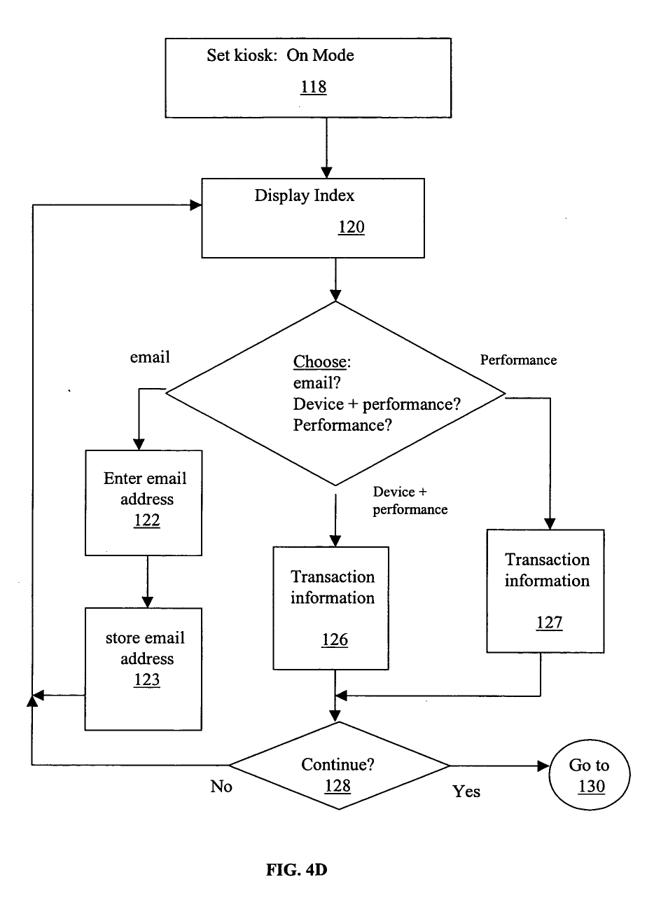

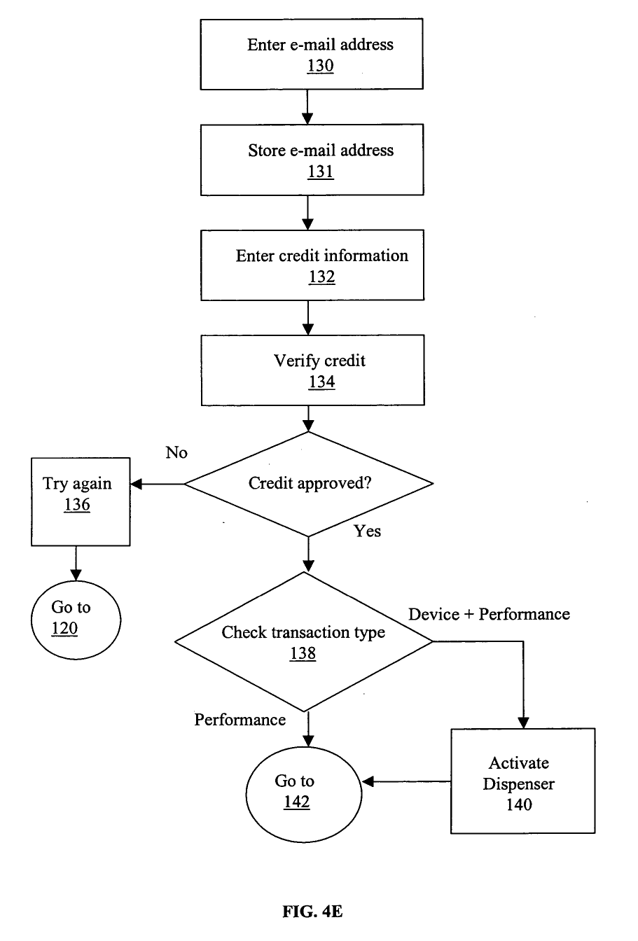

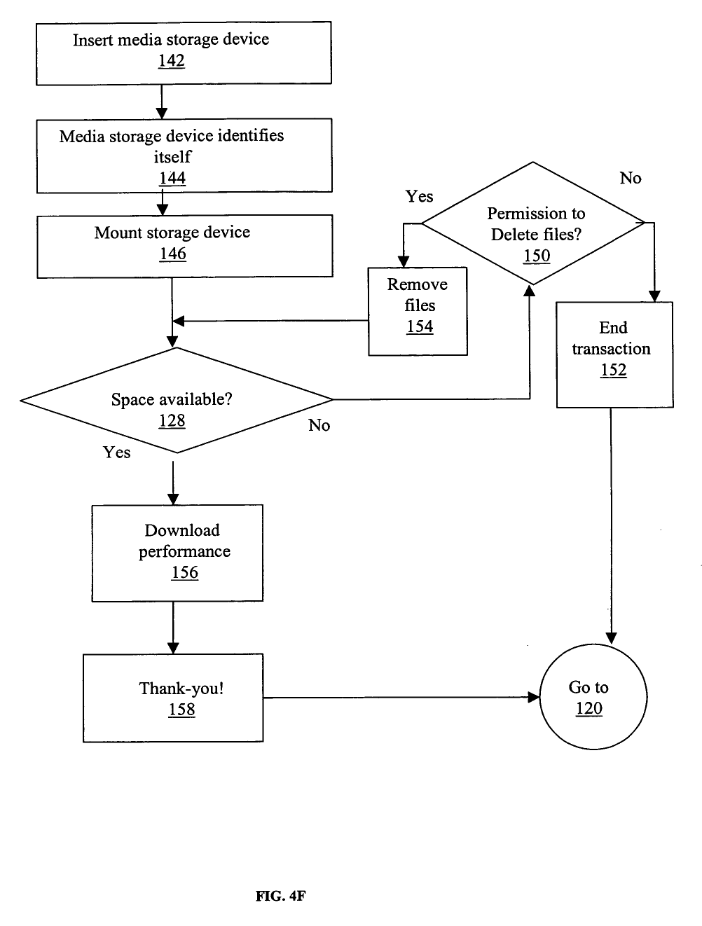

Referring to FIGS. 4A through 4F, a preferred method of providing live performance recordings according to the present invention is illustrated. Referring to FIG. 4A, the steps of recording the live performance are detailed. A producer supervises performance recording and kiosk operation. During start-up 100, and the producer verifies that the components 2, 16, 20, 32, 34 are in communication from the production means 16, the producer sets the kiosk 20 in a wait mode in step 102. The kiosk 20 can be put in wait mode any time it is desirable not to accept sales transactions. It is particularly advantageous to place the kiosk 20 in wait mode during the time that a show is being recorded (steps 104,106,108, 110, and 112, further described below), or otherwise at any time it is desirable to have the kiosk on, but not available for conducting transactions.

During production, the mastering means 2 records the live performance 104. Preferably, the live performance is recorded by using mixing console 12 to form a mixed signal from the sound signal taken from microphones 10 with a stereo feed at the venue mixing console 6. The frequencies from each source are mixed and equalized at the discretion of the producer to form the mixed signal. Preferably, the producer uses the mastering unit 14 to form a mastered signal still 104. The producer forms the mastered signal by compressing, limiting, and/or boosting the mixed signal to affect the sound quality. At step 106, the mastered signal is fed from the mastering means 2 to the production means 16, and the signal is recorded. Using music production software, the producer edits the recording 106 by splitting the master signal into tracks typically reflecting each song played during the performance. At step 108, the producer formats the recording by converting the track files into a digital format, for example a compressed format, and more specifically MP3 format. It will be appreciated by one of ordinary skill in the art that steps 104, 106, and 108 describe one example of forming live performance recording, and a wide variety of additional methods well known in the art may be used to form a live performance recording without departing from the scope of the present invention.

Once the producer forms the live performance recording, the producer may optionally tag the live performance recording 110 so that artist, song title, and track number can be correctly displayed by MP3 players. Administrative information, such as the band name, and the date of the performance, are entered into the database for tracking of sales, content, and publishing information associated with each performance. Next, the producer transfers the live performance recording to the kiosk 112. Preferably, the kiosk and production means are connected via an internal LAN 30. The internal LAN can be hard-wired or wireless. The producer also sets the kiosk 10 to an On mode in step 114, making the kiosk ready to take orders from consumers.

Referring to FIGS. 4B-4F, the operation of the kiosk is detailed. The kiosk must first determine which mode of operation has been set: wait mode or On mode. The Wait mode indicated that it is not desirable to accept sales transactions at that time while the On mode indicates that it is fully capable to conducting sales transaction for recordings of the live performances or media devices.

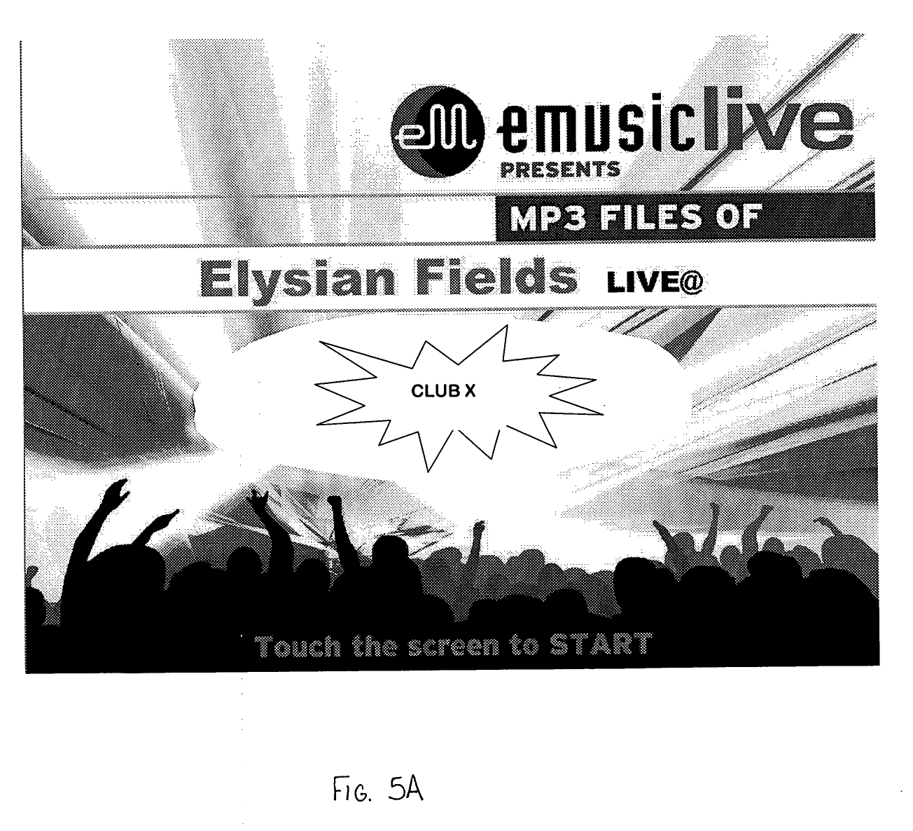

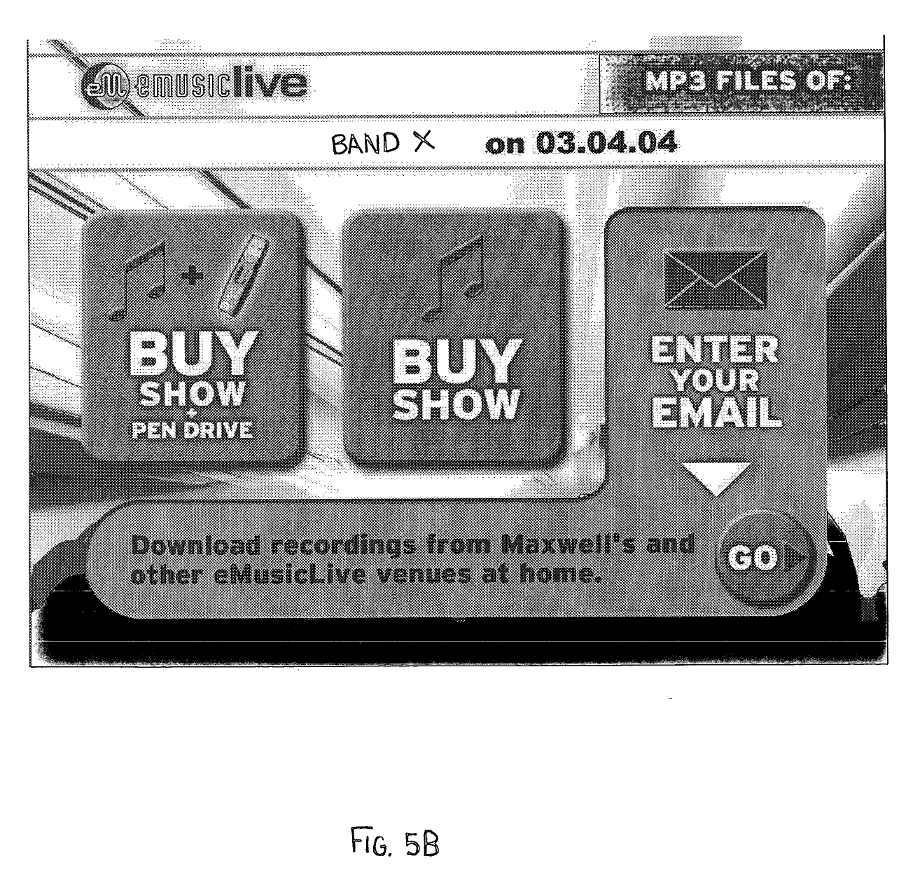

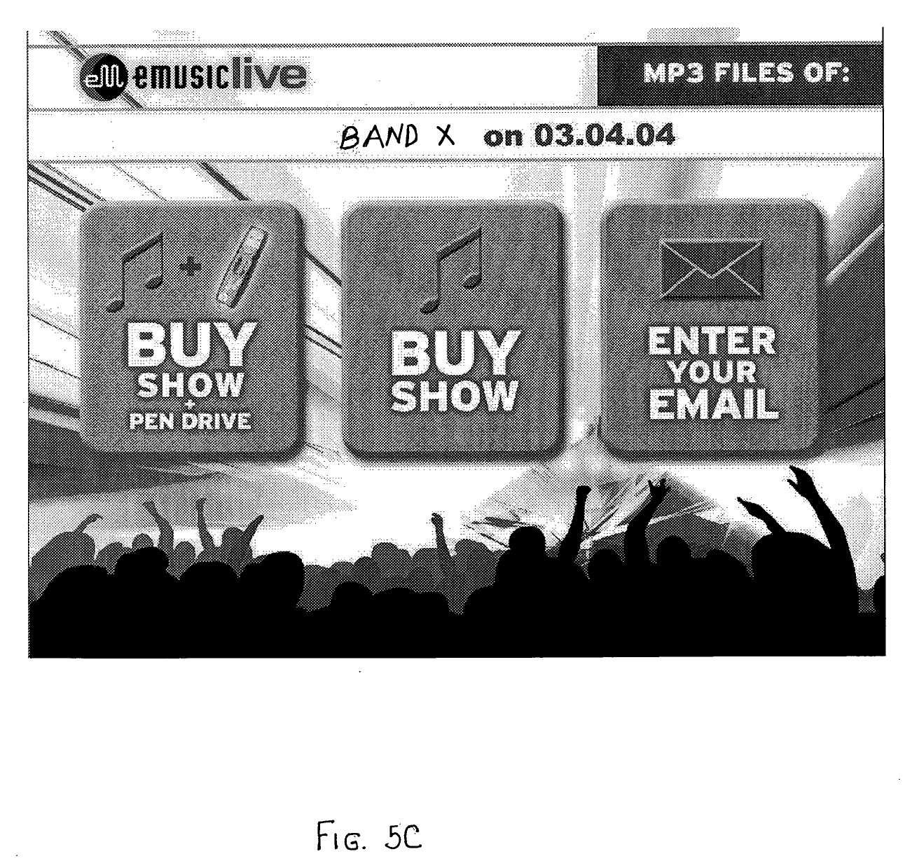

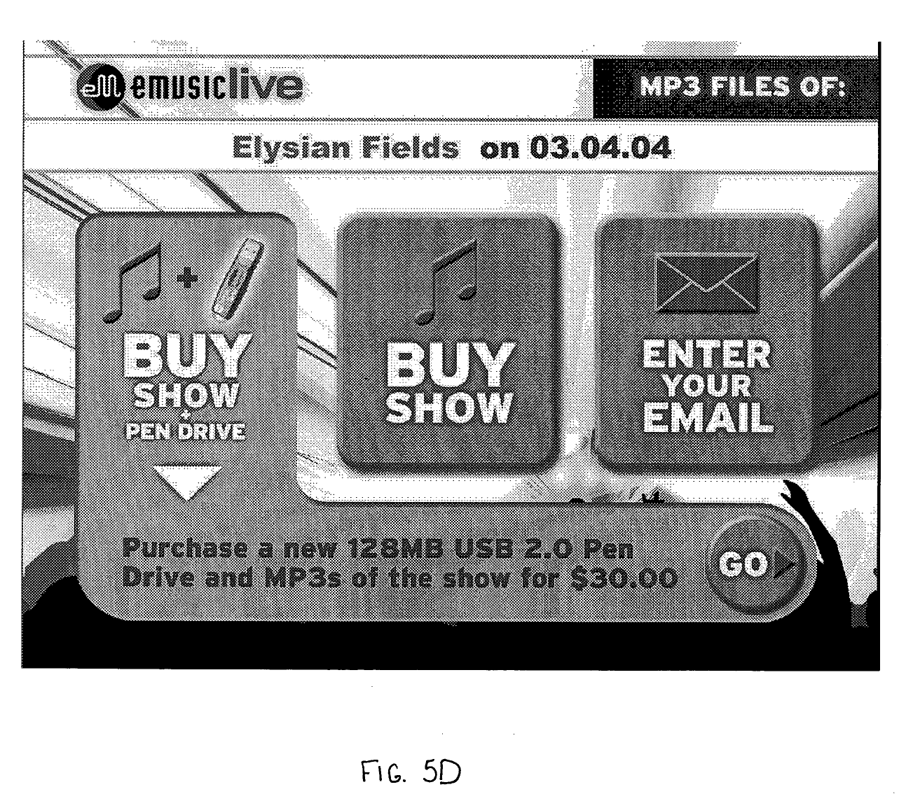

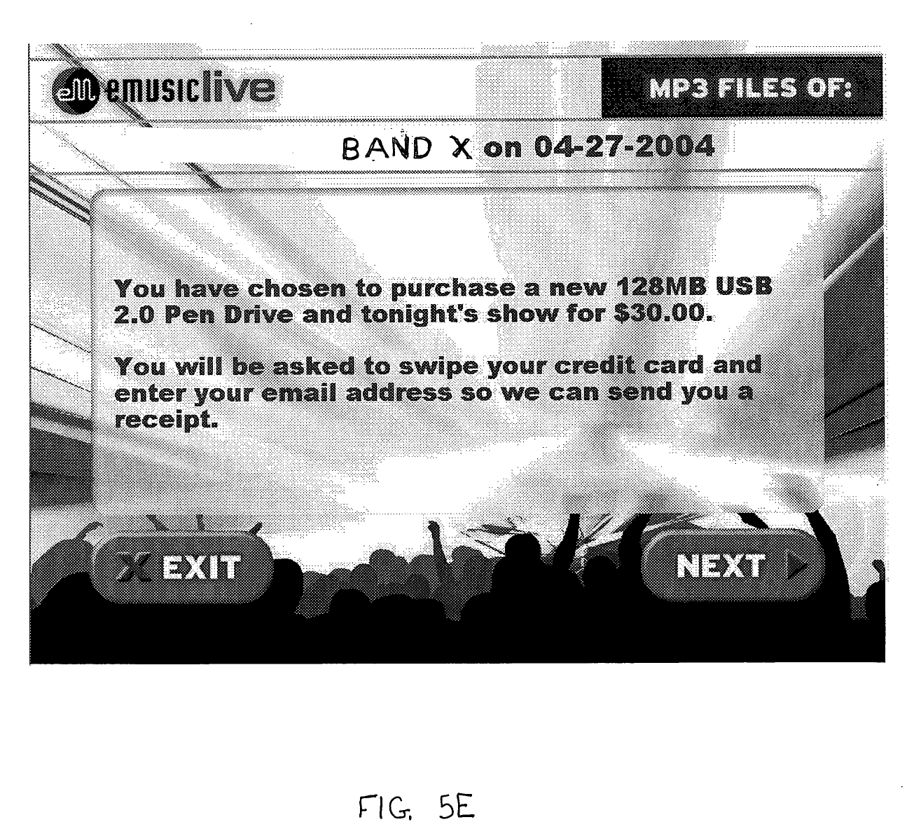

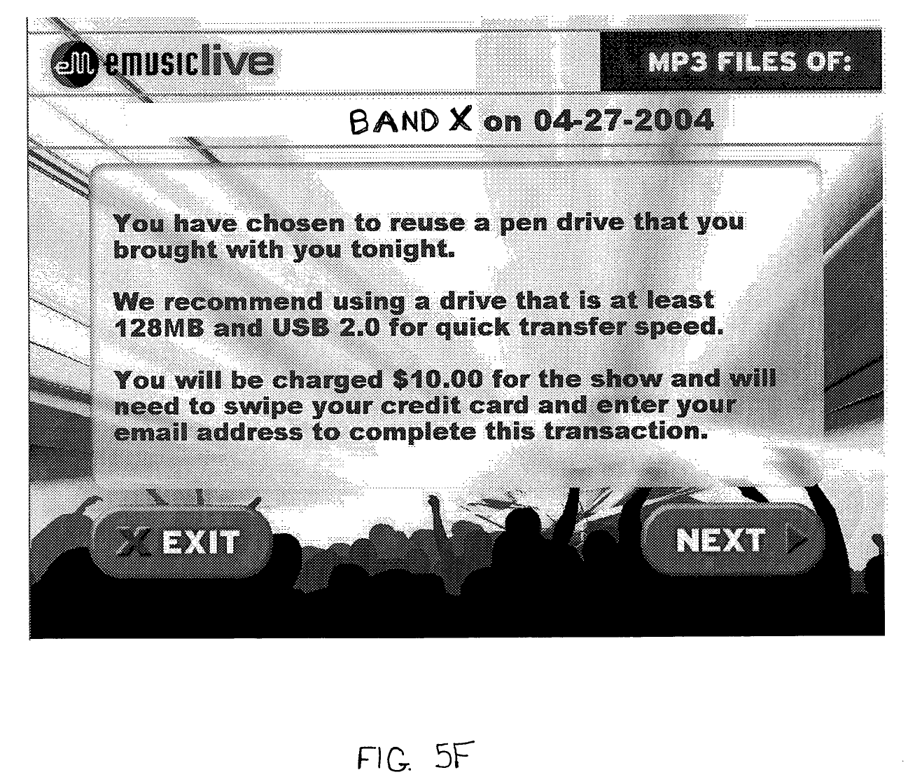

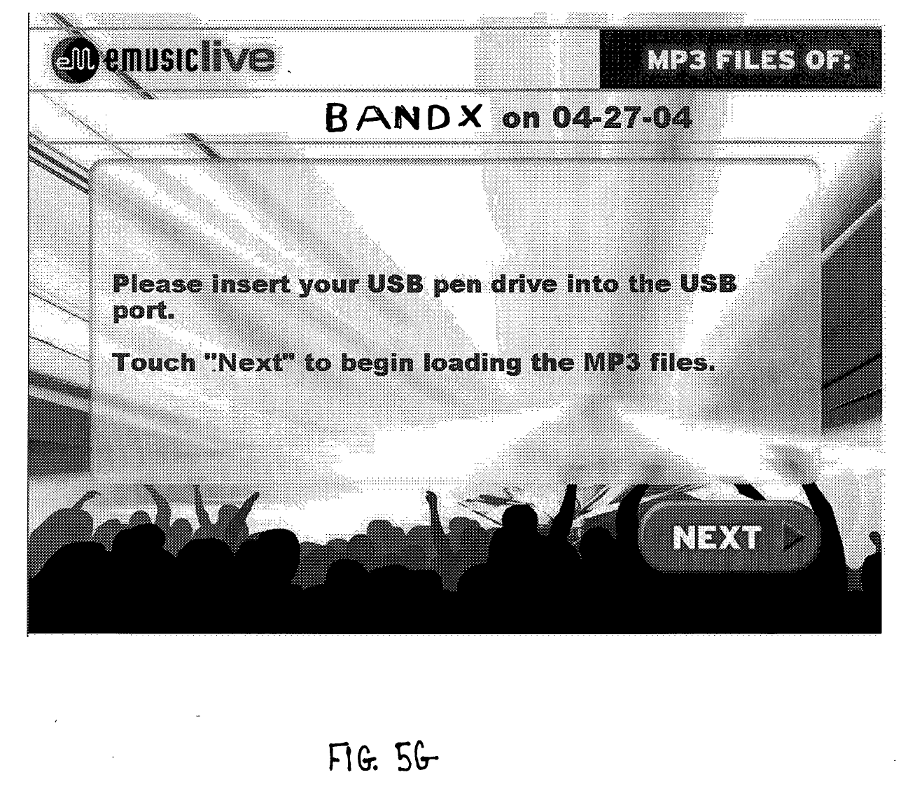

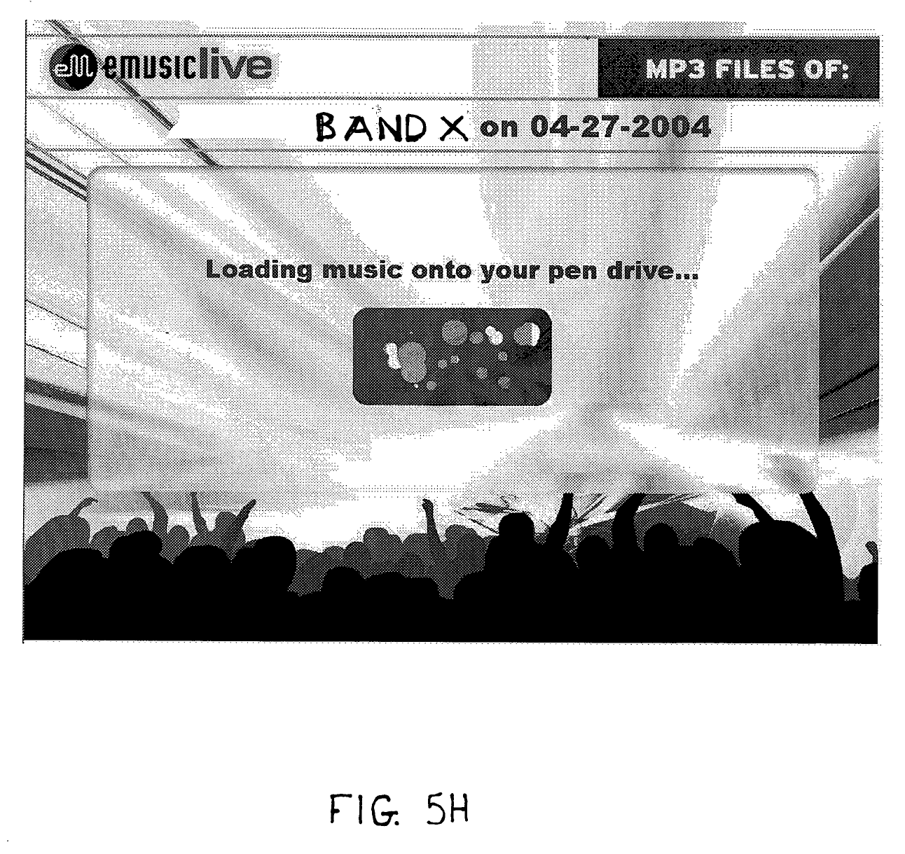

While in the wait mode, the kiosk is set to provide a display that informs the consumer of the kiosk's status. The kiosk 20 displays a start screen, as illustrated by the exemplary start screen in FIG. 5A, when functioning, but not being used by a consumer. While in wait mode, sales and marketing information can still be collected from consumers. If a consumer attempts to use the kiosk 20 while it is in wait mode 103, the kiosk displays a web page allowing a consumer to enter his or her email address 105, further illustrated in FIG. 5B. The consumer's email address is stored on the kiosk computer's hard drive and in the central database 107. The consumer will not be able to perform any sales transactions until the kiosk has been set to the On Mode.

Referring to FIG. 5C, an exemplary view of the kiosk when set to the on mode is illustrated. According to the present invention, the live performance recording is provided at the kiosk 20 approximately between eight and 15 minutes, and preferably in approximately 10 minutes after the performance has concluded.

Still referring to FIGS. 4B through 4F, the digital media recording is now available for purchase at the kiosk. When the consumer approaches the kiosk and touches the screen, the consumer is offered an index with several choices of how to proceed 120. In a preferred embodiment, and as further illustrated in FIG. 5D, the consumer can choose whether to buy both the digital media recording and a media storage device, just the digital media recording, or to enter an email address for receiving future sales information. If the consumer chooses email only, the consumer is prompted to enter an email address 122. Preferably, a key board touch screen is displayed which allows the consumer to enter the email address. The email address is stored at the kiosk computer 123 and the central database. If the consumer has chosen to simply enter an email address, an information screen may optionally be provided 124 which includes marketing information, for example, information about making future purchases, and may also indicate the email address has been accepted. A time setting, typically between 5 and ten seconds, automatically ends the process and returns the kiosk back to the index screen 120.

Referring back to step 120, if the consumer chooses to buy a live performance recording and a storage device 26, the consumer is preferably provided an information screen 126, as exemplified by FIG. 5E, providing the transactions costs, and information on further executing the transaction. The consumer is also prompted to continue or exit 128. If the consumer chooses to exit, the kiosk returns to the index at step 120 for the next consumer. If the consumer chooses to continue, the kiosk proceeds to step 130. If at step 120, the consumer chooses to purchase a live performance recording only, the kiosk computer preferably provides an information screen 127, as exemplified in FIG. 5F, providing the transactions costs, and information on further executing the transaction. The consumer is prompted to continue or exit 128. If the consumer chooses to exit, the kiosk returns to the index at step 120 for the next consumer. If the consumer chooses to continue, the kiosk proceeds to step 130.

At step 130, the consumer is prompted to enter an email address. The email address is stored in the kiosk computer memory 131. At step 132, the consumer is prompted to enter credit information, and preferably to swipe a credit card through the card reader 21. The kiosk computer verifies the credit card information 134 by transmitting the consumer's credit card number and email address to the credit card sales server 32. If the credit card is not approved, the kiosk cycles an information screen informing the consumer and asking the consumer to try again or exit 136. After the information screen cycle is complete, the kiosk computer then returns to step 120 to accept another transaction.

If the purchase is approved, the kiosk computer checks the type of transaction selected 138. If the consumer purchased a media storage device, the kiosk computer activates the dispenser 140 to dispense a digital media storage device 26. In either case, the kiosk then proceeds to step 142, and begins the downloading process. For all approved purchases, the credit card sales server 32 subsequently sends the consumer a sales receipt to the e-mail address provided, as is commonly known in the art.

At step 142, and as exemplified in FIG. 5G, the kiosk computer displays a screen prompting the consumer to insert the media storage device 26, whether purchased at the time or pre-owned, into the USB port 24. Once inserted, the media storage device 26 automatically identifies itself to the kiosk computer as is commonly known in the art 144. Next, at step 146, the kiosk computer mounts the media storage device by comparing the device identification to the USB configuration files. As previously described, the kiosk computer USB configuration files are preferably altered with wild card designators to recognize many types of media storage devices. Once the device 26 is identified, the kiosk computer next checks the media storage device's 26 storage capability 148. If the device 26 does not have enough space available to store the live performance recording, at step 150, the kiosk computer provides a screen prompting the consumer to delete files currently stored on the media storage device 26. If the consumer does not wish to clear the media storage device 26, the kiosk computer ends the transaction by cycling an information screen informing the consumer that the transaction has been cancelled 152, and returns to step 120. If the consumer does clear the media storage device 26, the kiosk computer removes all the files currently stored 154. Preferably, the consumer is allowed to remove either all or none of the files currently stored, so that each consumer's transaction time is kept to the shortest amount possible. However, the removal step 154 optionally allows the consumer to choose which files to delete from the media storage device 26. After a removal step 154, the kiosk computer re-verifies whether the media storage device 26 has sufficient space to accept the live performance recording.

Once the media storage device's 26 capacity is acceptable, at step 156, the kiosk computer downloads a copy of the live performance recording onto the media storage device 26. Preferably, during the downloading 156, the kiosk computer further provides an information screen, as exemplified in FIG. 5H, showing that the download is in progress, and preventing any premature removal of the media storage device 26. Once the download is complete, the kiosk computer cycles an information screen thanking the consumer for the purchase 158, and then returns to step 120 to accept a new transaction.

As previously discussed, when a consumer's email address information is entered at the kiosk 20, namely, steps 107 and 131, the email address is stored in the kiosk computer. The kiosk computer may or may not be powered on at all times, typically depending upon whether the kiosk is permanently or temporarily installed at the venue. If the kiosk is permanently installed, the kiosk computer is programmed to download consumer email information at regular intervals to the administrative server 34. If the kiosk is not permanently installed, the email information can be downloaded to the administrative server 34 after sales are closed, or manually retrieved and transferred to the administrative server 34 at any time via disk, CD ROM, or the like. Similarly, sales information is downloaded from the credit server 32 to the administrative server 34 at regular intervals. Performers who sell live performance recording are provided a password and login identification, and can access the administrative server 34 to check sales data after the performance.

The kiosk is left in the on mode after performances. It is put back into wait mode at the beginning of the next performance to avoid confusion. The kiosk is placed in Off mode when there is a technical difficulty and the kiosk cannot function properly. The kiosk 20 does not accept any transactions or collect email information in the Off mode.

In an alternative embodiment, the kiosk 20 stores and executes instructions for displaying a technical difficulty information screen. In some instances, a system problem may occur where the production means 16 and the kiosk 20 are still in communication. If any problems occur with any part of the system, and it is desirable to not accept any information at the kiosk 20 at that time, the producer can set the kiosk to the off mode, and cue the display informing consumers that the kiosk is unavailable due to technical difficulties. The kiosk computer also stores instructions for entering off mode when losing contact with the production means 16, and automatically posting a technical difficulties display. Once the problem is resolved, the kiosk can be re-set to On mode from the production means 16.

In an alternative embodiment, consumers can purchase live performance recording at later dates. For example, the kiosk 20 may be placed in a bar where bands play on certain evenings. On nights where a live performance is not being provided, the kiosk can be set to sell past performances. In this embodiment, the producer sets the kiosk to On mode. When the consumer elects to buy a show, the kiosk computer displays a menu of past, live shows. The consumer uses the touch screen to select the desired show. The consumer is then prompted to insert the media storage device 26, and the process otherwise continues as described above.

In one embodiment, the kiosk 20 may additionally be set to a demonstration mode. The demonstration mode allows a producer to demonstrate how the kiosk works without actually posting a transaction. The kiosk computer contains additional instructions that by-pass the credit server, and supply a dummy transaction approval. The kiosk then otherwise operates as in a real transaction. In this manner, the kiosk capability can be demonstrated to someone who potentially wants to put a kiosk-in a venue.

While the invention has been described as displaying information screens at the kiosk 20, it will be appreciated that any information screen can additionally provide advertisements for the consumer to view while only entering email information and while purchasing and downloading live performance recordings.

It is further contemplated that an alternative embodiment provides live performance recordings which include a video component. In this embodiment, the step of forming the live performance recording would necessarily include using video and sound recording equipment, to record the live performance, and edit the recording. Additionally, video editing software is included in the production means 16, for formatting the live performance recording.

While the invention has been described in detail with reference to preferred embodiments thereof, it will be apparent to one skilled in the art that various changes can be made, and equivalents employed, without departing from the scope of the invention.

What is claimed is:

1. A system for delivering live performance recordings to a consumer comprising:
a recording means for recording a live performance;
a production means electrically connected to the recording means for receiving said recording of the live performance; and
a kiosk comprising a media storage device dispenser, a USB port, a means for accepting sales information, a user interface, and a kiosk computer,
wherein the dispenser, USB port, means for accepting sales information and user interface are electrically connected to the kiosk computer, the kiosk computer stores and executes instructions for operating the dispenser, USB port, means for accepting sales information and user interface, and the kiosk computer is electrically connected to the production means; and said USB port is capable of transmitting said recording to a media storage device.

2. The system for delivering live performance recordings to a consumer of claim 1 wherein the live performance recording is a compressed audio file.

3. The system for delivering live performance recordings to a consumer of claim 2, wherein the compressed audio file is an MP3 file.

4. The system for delivering live performance recordings to a consumer of claim 1, wherein the kiosk USB port is a USB 2.0 port.

5. The system for delivering live performance recordings to a consumer of claim 1 wherein the media storage device dispenser dispenses a device selected from the group consisting of: a portable hard drive, a pen drive, a memory stick, a car radio transmitter, an MP3 player, a peripheral, and a flash card.

6. The system for delivering live performance recordings to a consumer of claim 5 wherein the media storage device is a pen drive.

7. The system for delivering live performance recordings to a consumer of claim 1 wherein the user interface is selected from the group consisting of a touch screen and a keyboard and a mouse peripherals.

8. The system for delivering live performance recordings to a consumer of claim 7 wherein the user interface is a touch screen.

9. The system for delivering live performance recordings to a consumer of claim 1 wherein the kiosk computer further comprises an operating system having USB configuration files including wildcard storage device descriptions.

10. The system for delivering live performance recordings to a consumer of claim 1, further comprising an administrative server electrically connected to the production means, and the kiosk computer via a distributed network, the administrative server storing one or more databases containing marketing and sales information for live performance recording transactions.

11. The system for delivering live performance recordings to a consumer of claim 1, wherein the recording means further comprises a pair of condenser microphones, a feed from a venues mixing console, a mixing console, and a mastering unit.

12. The system for delivering live performance recordings to a consumer of claim 1 wherein the production means further comprises at least one computer storing and executing software for creating digital files, for separating digital files into digital tracks, and for compressing digital files.

13. The system for delivering live performance recordings to a consumer of claim 1, wherein the production means and the kiosk computer are electrically connected by a distributed network and a LAN.

14. The system for delivering live performance recordings to a consumer of claim 1 further comprising a credit sales server connected to the kiosk computer and the production means through a distributed network.

15. The system for delivering live performance recordings to a consumer of claim 1 wherein the means for accepting credit information is selected from the group consisting of: a credit card reader, a biometric reader, and a touch screen keyboard.

16. A kiosk for the sale of live performance recordings comprising:
a kiosk computer having a processor and memory, and instructions stored in memory for conducting consumer transactions for live performance recordings and media storage devices;
a USB port electrically connected to the kiosk computer and capable of interfacing with media storage devices;
a means for accepting credit information electrically connected to the kiosk computer;
an interface for facilitating transactions electrically connected to the kiosk computer; and
a media storage device dispenser electrically connected to the kiosk computer;
wherein a consumer purchases a live media performance at the kiosk by selecting a performance at the interface, entering credit information through the means for accepting credit information, connecting a media storage device to the USB port, and receiving the live performance recording downloaded from the kiosk computer to the media storage device.

17. The kiosk of claim 16 wherein the consumer receives a media storage device from the dispenser.

18. The kiosk of claim 16 wherein the USB port is a USB 2.0 port.

19. The kiosk of claim 16 wherein the means for accepting credit information is selected from the group consisting of: a credit card reader, a biometric reader, a mouse and a keyboard peripherals, and a touch screen keyboard.

20. The kiosk of claim 16 wherein the interface for facilitating transactions is a touch screen.

21. The kiosk of claim 16 wherein the instructions stored in memory further comprises instructions for gathering email information from a consumer.

22. A method of providing live performance recordings to a consumer comprising the steps of:
storing a live performance recording at a kiosk;
accepting a consumer's credit information at the kiosk;
verifying the consumer's credit information;
providing a USB port for connecting a media storage device to the kiosk;
and downloading a copy of the live performance from the kiosk onto a storage device connected to the USB port.

23. The method of providing live performance recording to a consumer of claim 22 further comprising the step of dispensing a media storage device to the consumer.

24. The method of providing live performance recording to a consumer of claim 22, wherein the media storage device is selected from the group consisting of: a portable hard drive, a pen drive, a memory stick, a car radio transmitter, an MP3 player, a peripheral, and a flash card.

25. The method of providing live performance recording to a consumer of claim 24 wherein the media storage device is a pen drive.

26. The method of providing live performance recording to a consumer of claim 22, wherein the step of providing a USB port for connecting a media storage device to the kiosk further comprises providing a USB 2.0 port for connecting a media storage device to the kiosk.

27. The method of providing live performance recording to a consumer of claim 22, further comprising the steps, performed prior to storing live performance recording at a kiosk, of:
recording a live performance; and
editing the live performance recording; and
formatting the live performance recording.

28. The method of providing live performance recordings to a consumer of claim 27, further comprising the step of transferring the live performance recording to the kiosk via a local area network.

29. The method of providing live performance recording to a consumer of claim 22, further comprising the step of providing an administrative server for storing administrative information in at least one database.

30. The method of providing live performance recording to a consumer of claim 29 further comprising the steps of:
gathering email information from the consumer and storing it at the kiosk; and
downloading the email information from the consumer to the administrative server.

31. The method of providing live performance recording to a consumer of claim 22, wherein the step of verifying the consumer's credit information further comprises the steps of:
transmitting the consumer's credit information from the kiosk to a credit sales server; and
receiving a response from the credit sales server at the kiosk.

32. The method of providing live performance recordings to a consumer of claim 29, further comprising the step of providing access for at least one performer to the at least one database.

33. A system for delivering live performance recordings to a consumer comprising:
a recording means for recording a live performance;
a production means electrically connected to the recording means; and
a kiosk comprising a media storage device dispenser, a USB port, a means for accepting credit information, a user interface, and a kiosk computer, wherein the dispenser, USB port, means for accepting credit information and user interface are electrically connected to the kiosk computer, the kiosk computer stores and executes instructions for operating the dispenser, USB port, means for accepting credit information and user interface, and the kiosk computer and production means are electrically connected through a LAN and a distributed network; and
an administrative server electrically connected to the production means and the kiosk computer via a distributed network, the administrative server storing one or more databases containing marketing and sales information for live performance recording transactions and accessible to a performer via the distributed network.

34. A method of providing live performance recordings to a consumer comprising the steps of:
forming a live performance recording;
transmitting the live performance recording to a kiosk;
storing the live performance recording at the kiosk;
accepting a consumer's credit information at the kiosk;
verifying the consumer's credit information;
dispensing a media storage device at the kiosk to the consumer;
providing a USB port for connecting a media storage device to the kiosk; and
downloading a copy of the live performance from the kiosk onto a
storage device connected to the USB port.
